(19) United States
(12) Patent Application Publication
(10) Pub. No.: US 2026/0094992 A1
(43) Pub. Date: Apr. 2, 2026

(54) POSITION LIMITING PLUG, CONNECTOR ASSEMBLY, AND CONNECTION PLUG ASSEMBLY

(71) Applicant: ATEN INTERNATIONAL CO., LTD., New Taipei City (TW)

(72) Inventors: Chih-Ming CHEN, New Taipei City (TW); You-Lin SHIH, New Taipei City (TW)

(21) Appl. No.: 19/308,319

(22) Filed: Aug. 25, 2025

(30) Foreign Application Priority Data
Sep. 30, 2024 (TW) 113137290

(51) Int. Cl. H01R 13/629; H01R 13/639

(52) U.S. Cl. CPC H01R 13/629; H01R 13/639

(57) ABSTRACT

A position limiting plug includes a main body and a flexible arm structure. The main body has a stop wall. The flexible arm structure extends from a front side of the main body and outwardly towards a direction away from the stop wall, and is configured to be inserted into a first insertion port of a connector. There is a gap between the flexible arm structure and the main body. A bottom surface of the flexible arm structure has an abutting portion adjacent to the gap, and a bottom end of the abutting portion is lower than a bottom surface of the main body. After a male connector plug is inserted into a second insertion port of the connector, the abutting portion is configured to abut against the male connector plug so as to rotate toward the gap.

### CROSS-REFERENCE TO RELATED APPLICATION

This application claims priority to Taiwan Application Serial Number 113137290, filed September 30, 2024, which is herein incorporated by reference.

### BACKGROUND

### Field of Invention

The present disclosure relates to a position limiting plug, a connector assembly having the position limiting plug, and a connection plug assembly having the position limiting plug.

### Description of Related Art

The composite connectors currently on the market have developed a stacked multi-port structure, and port interfaces may be different types, such as a composite connector having an upper DP insertion port and a lower HDMI insertion port.

However, due to the structural design of the composite connector, when only the lower HDMI insertion port is used, since the DP insertion port is above an inserted HDMI plug, the position of the upper edge of the HDMI plug is merely limited by the pin structure of the upper DP insertion port, and the pin structure of the upper DP insertion port receives the reaction force of the upward displacement of the HDMI plug, such that the stability of the HDMI plug is greatly reduced. As a result, compared with a traditional connector having a single HDMI insertion port, the HDMI plug of the aforementioned composite connector is more likely to become detached.

### SUMMARY

According to some embodiments of the present disclosure, a position limiting plug for inserting a connector having a first insertion port and a second insertion port that are spatially connected includes a main body and an extending structure. The main body has a stop wall at a rear side of the main body. The extending structure extends from a front side of the main body and outwardly towards a direction away from the stop wall, and is configured to insert into the first insertion port of the connector. There is a gap between the extending structure and the main body. A bottom surface of the extending structure has an abutting portion adjacent to the gap. A bottom end of the abutting portion is lower than a bottom surface of the main body. After a male connector plug is inserted into the second insertion port of the connector, the abutting portion is configured to abut against the male connector plug so as to rotate toward the gap.

According to some embodiments of the present disclosure, a connector assembly includes a connector and a position limiting plug. The connector has a first insertion port and a second insertion port that are disposed side by side, wherein the first insertion port and the second insertion port are at least partially spatially connected. The position limiting plug includes a main body and an extending structure. The main body has a stop wall at a rear side of the main body. The extending structure extends from a front side of the main body and outwardly towards a direction away from the stop wall, and is configured to insert into the first insertion port of the connector. There is a gap between the extending structure and the main body. A bottom surface of the extending structure has an abutting portion adjacent to the gap. A bottom end of the abutting portion is lower than a bottom surface of the main body. After a male connector plug is inserted into the second insertion port of the connector, the abutting portion is configured to abut against the male connector plug so as to rotate toward the gap.

According to some embodiments of the present disclosure, a connection plug assembly includes a connection cable and a position limiting plug. The connection cable includes a male connector plug and a wire. The male connector plug has a first end and a second end, the first end is configured to insert into a second insertion port of a connector, and the second end connects the wire. The position limiting plug is connected to the connection cable and includes a main body and an extending structure. The main body has a stop wall at a rear side of the main body. The extending structure extends from a front side of the main body and outwardly towards a direction away from the stop wall, and is configured to insert into a first insertion port of the connector, wherein a bottom surface of the extending structure has an abutting portion. When the extending structure is inserted into the first insertion port and the male connector plug is inserted into the second insertion port, the abutting portion of the extending structure is configured to abut against the male connector plug.

In the aforementioned embodiments of the present disclosure, since the position limiting plug having the extending structure can be inserted into the first insertion port of the connector, and there is a gap between the extending structure and the main body, and the bottom end of the abutting portion is lower than the bottom surface of the main body, after the male connector plug is inserted into the second insertion port of the connector, the abutting portion of the extending structure can abut against the top surface of the male connector plug to rotate toward the gap and apply an elastic pressing force to the male connector plug. The position limiting plug can not only improve the pull-out force for the male connector plug that is inserted into the second insertion port to prevent separating, but also change the position of a reaction force when the male connector plug is inserted to prevent damaging the pins of the first insertion port through the structural design of the position limiting plug without affecting the overall appearance size of the connector. Moreover, when the male connector plug is not inserted into the connector, the position limiting plug can be easily detached, which is convenient for use.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a position limiting plug of a connector assembly before inserting into a first insertion port of a connector according to one embodiment of the present disclosure.

FIG. 2 is a perspective view of the position limiting plug of FIG. 1 after inserting into the first insertion port of the connector.

FIG. 3 is a cross-sectional view of a second insertion port of the connector of FIG. 2 when being inserted by a male connector plug taken along line 3-3’.

FIG. 4 is a cross-sectional view of the second insertion port of the connector of FIG. 3 after being inserted by the male connector plug.

FIG. 5 is a front view of an abutting portion according to another embodiment of the present disclosure.

FIG. 6 is a front view of an abutting portion according to still another embodiment of the present disclosure.

FIG. 7 is a perspective view of a position limiting plug after inserting into a first insertion port of a connector and a male connector plug after inserting into a second insertion port of the connector according to another embodiment of the present disclosure.

FIG. 8 is a perspective view of a position limiting plug after inserting into a first insertion port of a connector and a male connector plug after inserting into a second insertion port of the connector according to still another embodiment of the present disclosure.

FIG. 9 is a perspective view of a position limiting plug after inserting into a first insertion port of a connector and a male connector plug after inserting into a second insertion port of the connector according to yet another embodiment of the present disclosure.

FIG. 10 is a perspective view of a position limiting plug after inserting into a first insertion port of a connector and a male connector plug after inserting into a second insertion port of the connector according to one embodiment of the present disclosure.

FIG. 11 is a top view of FIG. 10.

FIG. 12 is a perspective view of a position limiting plug after inserting into a first insertion port of a connector and a male connector plug after inserting into a second insertion port of the connector according to another embodiment of the present disclosure.

FIG. 13 is a top view of FIG. 12.

### DETAILED DESCRIPTION

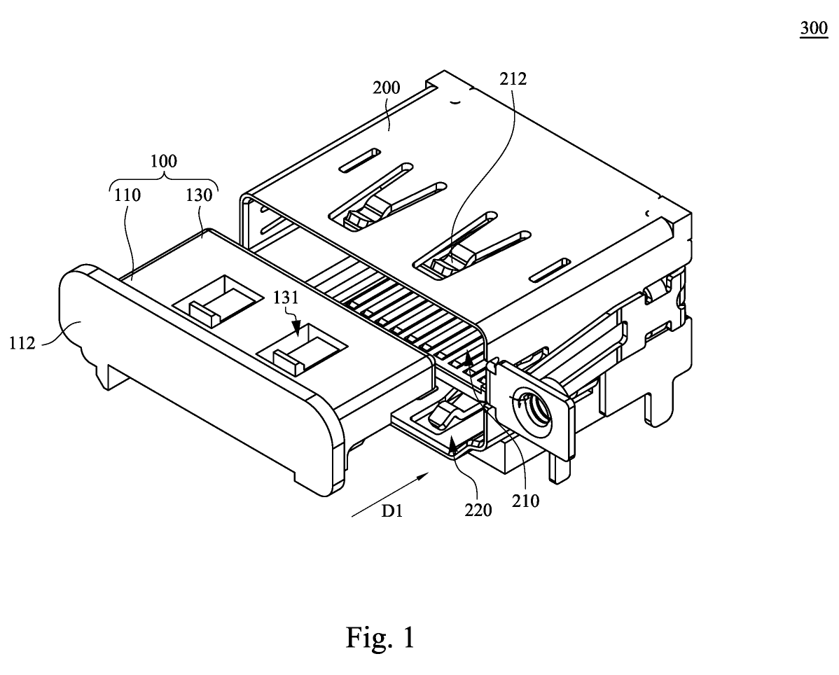

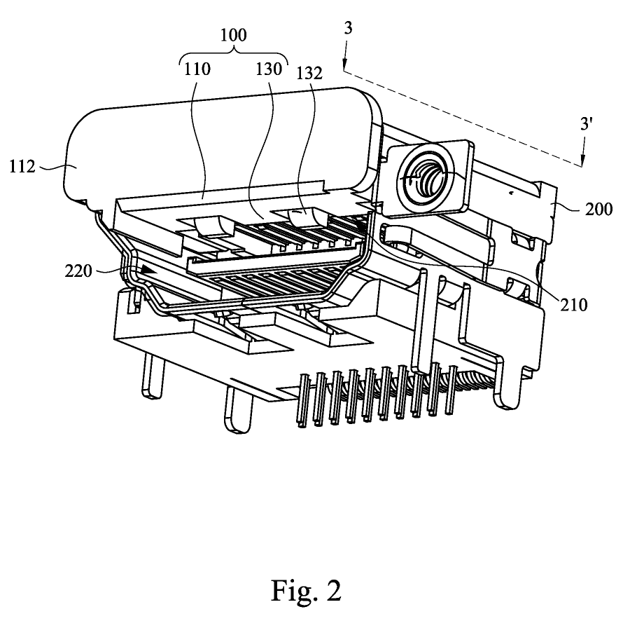

FIG. 1 is a perspective view of a position limiting plug 100 of a connector assembly 300 before inserting into a first insertion port 210 of a connector 200 according to one embodiment of the present disclosure. FIG. 2 is a perspective view of the position limiting plug 100 of FIG. 1 after inserting into the first insertion port 210 of the connector 200. As shown in FIGS. 1 and 2, the connector assembly 300 includes the connector 200 and the position limiting plug 100. The connector 200 has the first insertion port 210 and a second insertion port 220 that are disposed side by side. For example, the first insertion port 210 and the second insertion port 220 may be disposed side by side in a vertical direction (e.g., a stacked arrangement), disposed side by side in a horizontal direction, or disposed side by side in any other possible arrangement. The first insertion port 210 and the second insertion port 220 are at least partially spatially connected. In some embodiments, the outline of the edges of the two ports (i.e., the inlet of the position limiting plug and the inlet of a male connector plug) may be referred to as a large connected hole. The first insertion port 210 and the second insertion port 220 may be different ports. For example, the width of the first insertion port 210 is greater than the width of the second insertion port 220. In some embodiments, the first insertion port 210 and the second insertion port 220 are different image ports, the first insertion port 210 may be DP port, and the second insertion port 220 may be HDMI port. However, the present disclosure is not limited to the aforementioned ports.

The position limiting plug 100 may be detachably disposed in the first insertion port 210 of the connector 200. The position limiting plug 100 includes a main body 110 and an extending structure 130. The main body 110 has a stop wall 112 at the rear side of the main body 110. The stop wall 112 may be used to abut against a connection cable inserted into the second insertion port 220 and to abut against the edge of the first insertion port 210, and the stop wall 112 also facilitates the user to push in or pull out the position limiting plug 100 from the first insertion port 210 of the connector 200. The extending structure 130 extends from the front side of the main body 110 and outwardly towards a direction D1 away from the stop wall 112, and is configured to insert into the first insertion port 210 of the connector 200. In some embodiments, the main body 110 and the extending structure 130 of the position limiting plug 100 may be integrally formed as a single plastic piece.

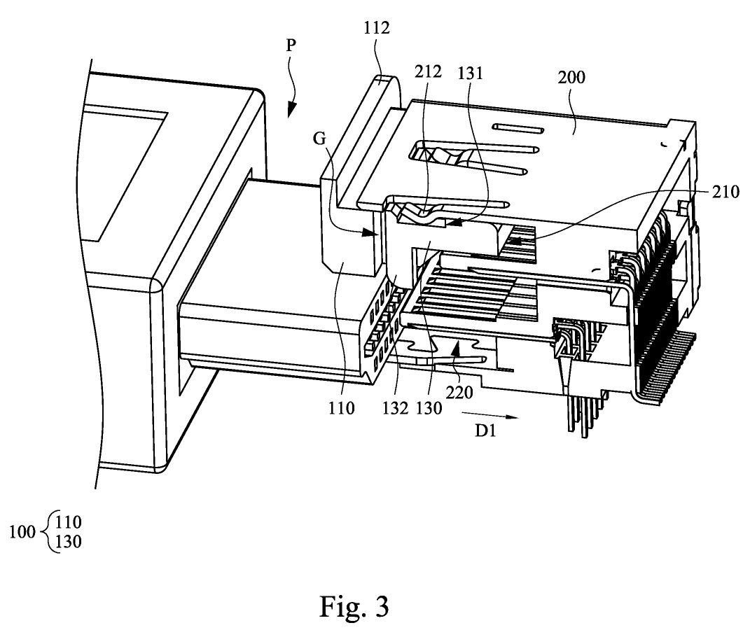

FIG. 3 is a cross-sectional view of the second insertion port 220 of the connector 200 of FIG. 2 when being inserted by a male connector plug P taken along line 3-3’. As shown in FIGS. 2 and 3, an end of a connection cable is the male connector plug P, such as a HDMI connection plug. Before the male connector plug P is inserted into the second insertion port 220 of the connector 200 in the direction D1, the position limiting plug 100 has been inserted into the first insertion port 210 of the connector 200 so as to be positioned. There is a gap G between the extending structure 130 and the main body 110 of the position limiting plug 100. The bottom surface of the extending structure 130 has an abutting portion 132. The abutting portion 132 is adjacent to the gap G, and the bottom end of the abutting portion 132 is lower than the bottom surface of the main body 110. Such a design can enable the abutting portion 132 of the extending structure 130 to move toward the gap G when receiving a force. Accordingly, the extending structure 130 may act as a flexible arm structure.

In this embodiment, the top surface of the extending structure 130 of the position limiting plug 100 has a recess 131. When the position limiting plug 100 is inserted into the first insertion port 210 of the connector 200, a hook portion 212 of the connector 200 can be coupled with the recess 131 of the extending structure 130 so as to be positioned and to provide a user with a positioning hand feel.

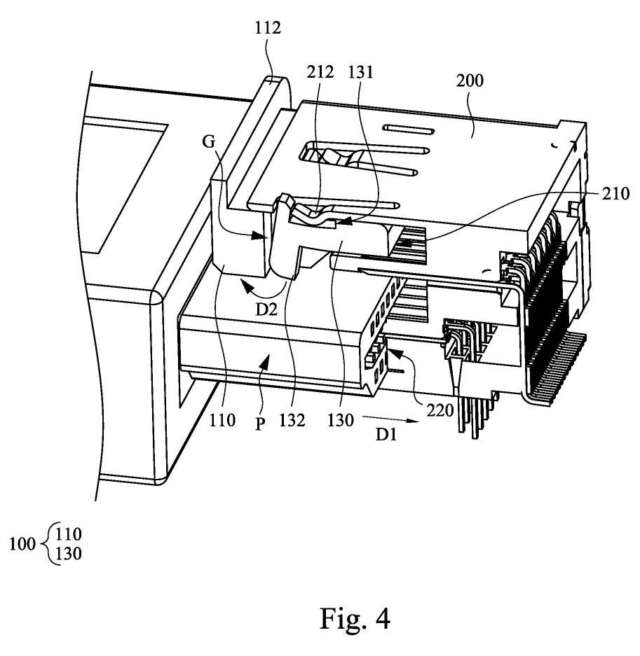

FIG. 4 is a cross-sectional view of the second insertion port 220 of the connector 200 of FIG. 3 after being inserted by the male connector plug P. As shown in FIG. 3 and FIG. 4, after the male connector plug P is inserted into the second insertion port 220 of the connector 200, the abutting portion 132 of the extending structure 130 abuts against the male connector plug P to enable the abutting portion 132 to rotate toward the gap G in a direction D2. As a result, the abutting portion 132 of the extending structure 130 can apply an elastic pressing force to the male connector plug P, thereby preventing the male connector plug P separating from the connector 200. In this state, the stop wall 112 of the position limiting plug 100 may abut against the sidewall of the insulator located on the male connector plug P to serve as a stopper, which can prevent the male connector plug P from being excessively inserted into the second insertion port 220 and causing damage to the connector 200 or the male connector plug P.

Specifically, since the position limiting plug 100 having the extending structure 130 can be inserted into the first insertion port 210 of the connector 200, and there is the gap G between the extending structure 130 and the main body 110, and the bottom end of the abutting portion 132 of the extending structure 130 is lower than the bottom surface of the main body 110, after the male connector plug P is inserted into the second insertion port 220 of the connector 200, the abutting portion 132 of the extending structure 130 can abut against the top surface of the male connector plug P to rotate toward the gap G and apply an elastic pressing force to the male connector plug P. The position limiting plug 100 can not only improve the pull-out force for the male connector plug P that is inserted into the second insertion port 220 so as to prevent separating, but also change the position of a reaction force when the male connector plug P is inserted into the second insertion port 220 through the structural design of the position limiting plug 100 so as to prevent damaging the pins of the first insertion port 210 without affecting the overall appearance size of the connector 200. Moreover, when the male connector plug P is not inserted into the connector 200, the position limiting plug 100 can be easily detached (e.g., pulling out the position limiting plug 100 in an opposite direction to the direction D1), which is convenient for use.

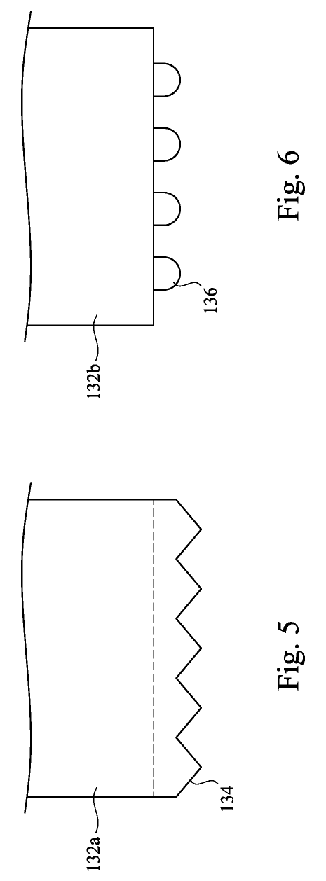

FIG. 5 is a front view of an abutting portion 132a according to another embodiment of the present disclosure. The bottom end of the abutting portion 132a may have a wavy structure 134, and the wavy structure 134 may be a jagged structure (see FIG. 5), thereby improving the stability for the male connector plug P. The wavy structure 134 and the abutting portion 132a may be integrally formed as a single piece having the same material, such as plastic. In some embodiments, the wavy structure 134 and the abutting portion 132a may be different materials. For example, the material of the wavy structure 134 may be rubber or silicone, but the present disclosure is not limited in this regard.

FIG. 6 is a front view of an abutting portion 132b according to still another embodiment of the present disclosure. The difference between this embodiment and the embodiment of FIG. 5 is that the bottom end of the abutting portion 132b of FIG. 6 has plural protruding points 136, thereby improving the stability for the male connector plug P. The protruding points 136 and the abutting portion 132b may be integrally formed as a single piece having the same material, such as plastic. In some embodiments, the protruding points 136 and the abutting portion 132b may be different materials. For example, the material of the protruding points 136 may be rubber or silicone, but the present disclosure is not limited in this regard.

It is to be noted that the connection relationships, the materials, and the advantages of the elements described above will not be repeated in the following description. In the following description, other types of position limiting plugs will be explained.

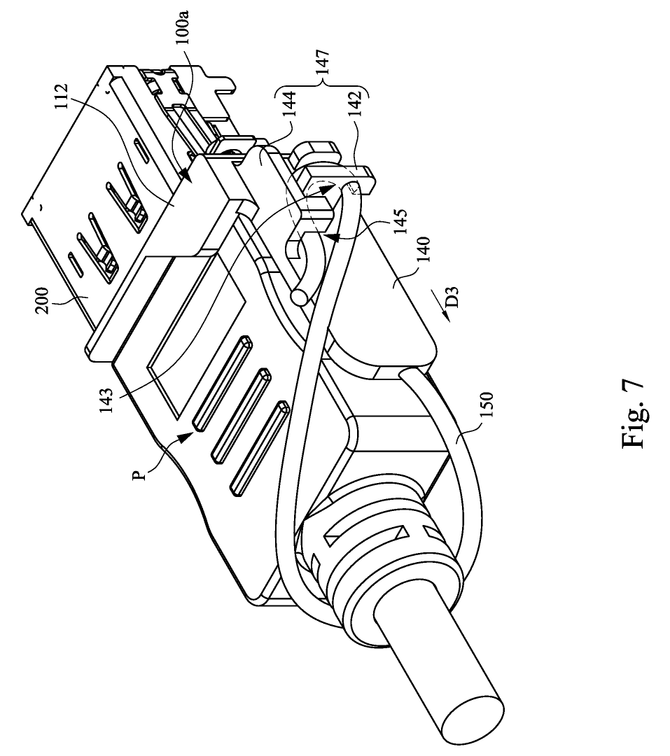

FIG. 7 is a perspective view of a position limiting plug 100a after inserting into the first insertion port 210 of the connector 200 and the male connector plug P after inserting into the second insertion port 220 (see FIG. 4) of the connector 200 according to another embodiment of the present disclosure. As shown in FIG. 4 and FIG. 7, the position limiting plug 100a further includes a winding portion 140 besides the aforementioned main body 110 and the extending structure 130, in which the winding portion 140 extends in a direction opposite to the extending direction of the extending structure 130 from the edge of the stop wall 112. In one embodiment, after the male connector plug P is inserted into the second insertion port 220 of the connector 200, an independent cable tie (not shown) may be used to wrap the male connector plug P and the winding portion 140 to achieve the effect of stabilizing the male connector plug P. In another embodiment, as shown in FIG. 7, the position limiting plug 100a further includes the winding portion 140 and a tied portion 150. The winding portion 140 of the position limiting plug 100a extends in a direction D3 from the edge of the stop wall 112, in which the direction D3 is opposite to the extending direction of the extending structure 130 (i.e., the direction D1). An end of the tied portion 150 extends outward form an end of the winding portion 140. After the male connector plug P is inserted into the second insertion port 220 of the connector 200, another end of the tied portion 150 can go around the male connector plug P so as to be positioned on the winding portion 140. Since the winding portion 140 can be connected and wrapped by the tied portion 150, the stability of the male connector plug P is further enhanced.

In this embodiment, the winding portion 140 of the position limiting plug 100a includes a fastening portion 147, and the tied portion 150 is fixed by the fastening portion 147 after the tied portion 150 goes around the male connector plug P. The fastening portion 147 includes a first fastening portion 142 and a second fastening portion 144. The first fastening portion 142 has a groove 143, and the second fastening portion 144 has a groove 145. The tied portion 150 can be sequentially fixed by the groove 143 of the first fastening portion 142 and the groove 145 of the second fastening portion 144 after the tied portion 150 goes around the male connector plug P. The position limiting plug 100a utilizes the two recess structures (i.e., the grooves 143 and 145) to limit the turning points of the tied portion 150 and change the direction of a pulling force, and thus the position limiting plug 100a may be suitable for different male connector plugs P with different shapes and can firmly secure the male connector plug P.

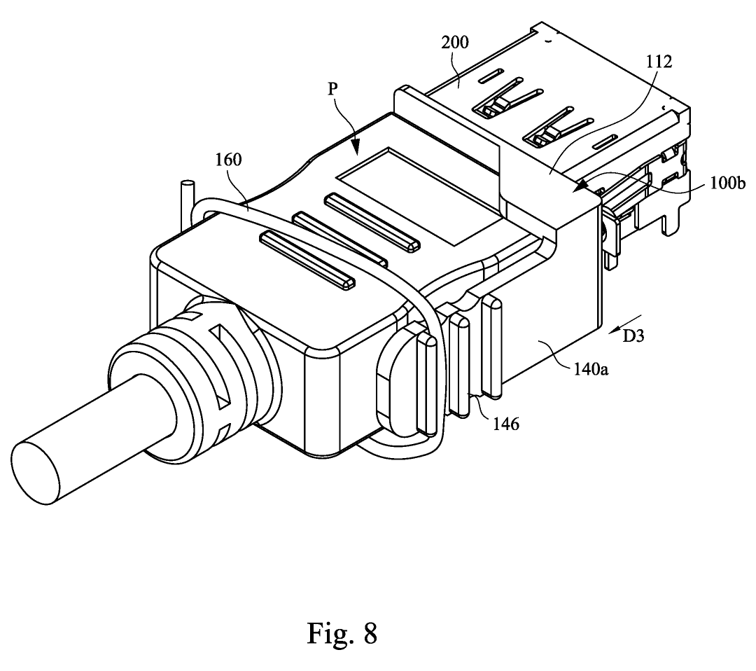

As shown in FIG. 8 and FIG. 4, a position limiting plug 100b further includes a winding portion 140a besides the aforementioned main body 110 and the extending structure 130. The difference between FIGS. 7 and 8 is that the winding portion 140a has at least two protruding ribs 146, such that a positioning concave portion is formed between the two protruding ribs 146. In this embodiment, after the male connector plug P is inserted into the second insertion port 220 of the connector 200, a cable tie 160 can be used to go around the male connector plug P so as to be positioned between the two protruding ribs 146 of the winding portion 140a. The number of the protruding ribs 146 of FIG. 8 is merely for an example, and may be varied as deemed necessary by designs. Since the winding portion 140a may be wrapped by the cable tie 160, the stability of the male connector plug P is further enhanced.

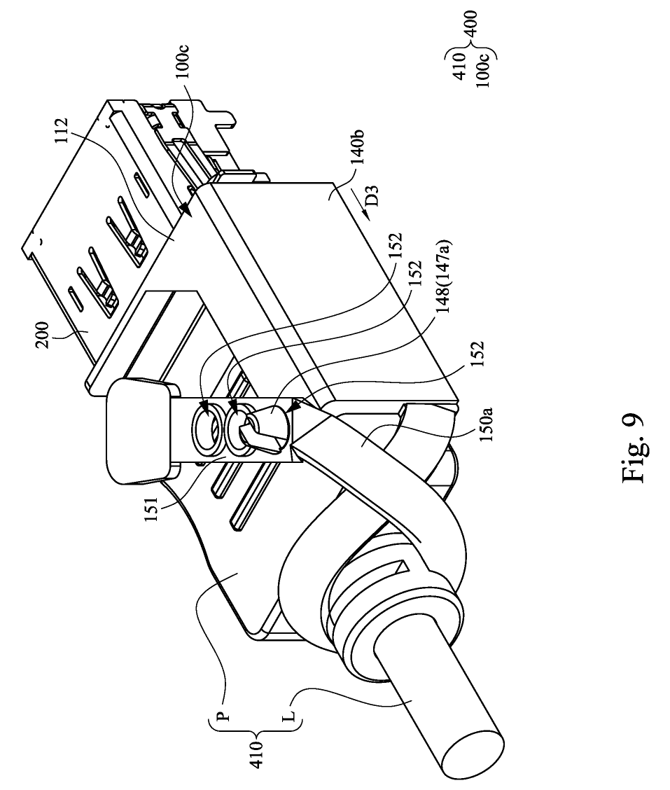

FIG. 9 is a perspective view of a position limiting plug 100c after inserting into the first insertion port 210 of the connector 200 and the male connector plug P after inserting into the second insertion port 220 (see FIG. 4) of the connector 200 according to yet another embodiment of the present disclosure. As shown in FIG. 4 and FIG. 9, the position limiting plug 100c further includes a winding portion 140b besides the aforementioned main body 110 and the extending structure 130. The difference between this embodiment and the embodiment of FIG. 7 is that the tied portion 150a of the winding portion 140b includes a positioning portion 151, and the positioning portion 151 of the tied portion 150a is configured to be coupled to and positioned on the fastening portion 147a (i.e., the third fastening portion) after the tied portion 150a goes around the male connector plug P. The positioning portion 151 has plural through holes 152. The fastening portion 147a of the winding portion 140b has a positioning protruding portion 148. One of the through holes 152 of the tied portion 150a can allow the positioning protruding portion 148 of the fastening portion 147a to pass through to fix the tied portion 150a after the tied portion 150a goes around the male connector plug P. Since the winding portion 140b can be connected and wrapped by the tied portion 150a, the stability of the male connector plug P is further enhanced.

The positioning protruding portion 148 in this embodiment includes two elastic pieces. In another embodiment, the positioning protruding portion 148 may be a spherical structure, and the diameter of the spherical structure may be slightly larger than the diameter of the through holes 152, thereby providing stability and positioning hand feel. However, the structures of the third fastening portion and the positioning portion are not limited to the aforementioned structures. The positioning portion may include plural protruding portions, and the third fastening portion has a through hole configured to position and fix one of the protruding portions.

In some embodiments, a connection plug assembly 400 includes a connection cable 410 and a position limiting plug 100c. The connection cable 410 includes the male connector plug P and a wire L. The first end of the male connector plug P is configured to be inserted into the second insertion port 220 of the connector 200, and the second end of the male connector plug P connects the wire L. The position limiting plug 100c is connected to the connection cable 410. The position limiting plug 100c of the connection plug assembly 400 can be used to replace the aforementioned position limiting plugs 100, 100a, and 100b and any one of following position limiting plugs 100d and 100e.

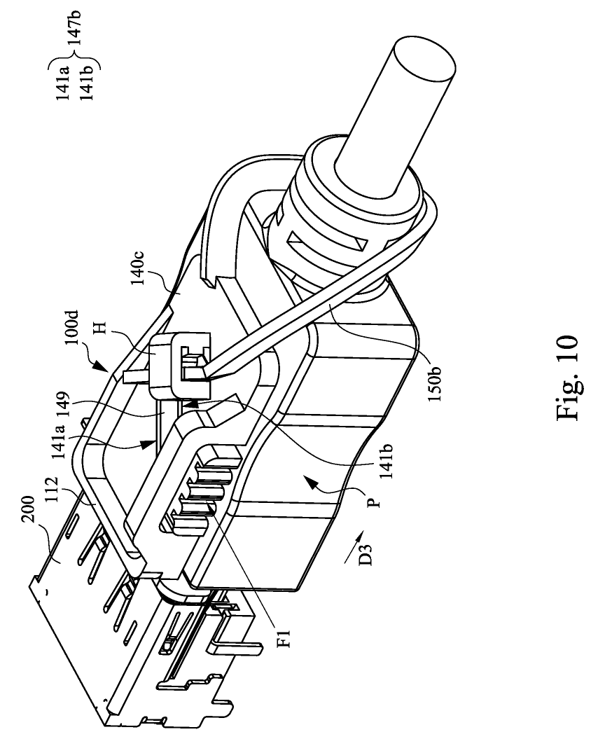

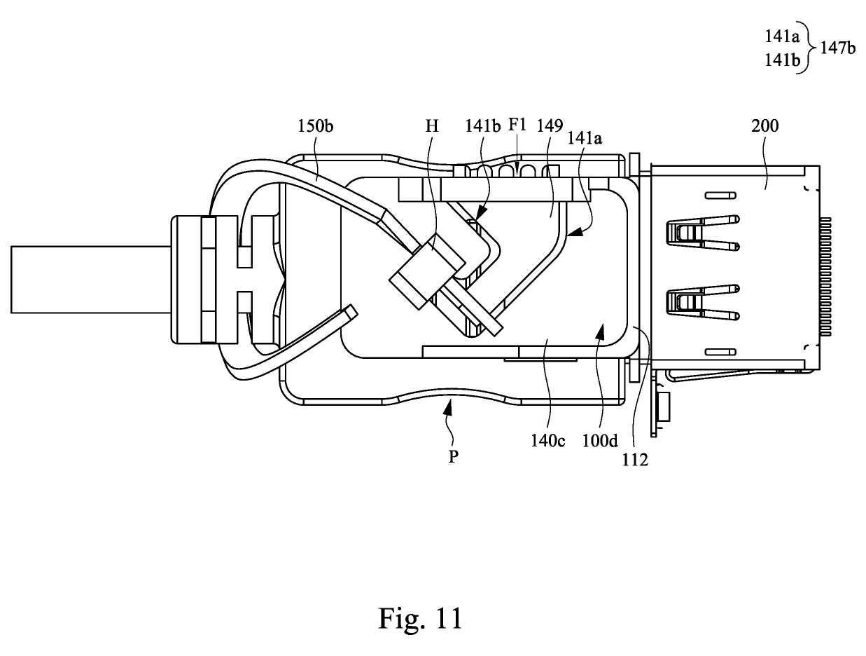

FIG. 10 is a perspective view of a position limiting plug 100d after inserting into the first insertion port 210 of the connector 200 and the male connector plug P after inserting into the second insertion port 220 (see FIG. 4) of the connector 200 according to one embodiment of the present disclosure. FIG. 11 is a top view of FIG. 10. As shown in FIGS. 10 and 11, the position limiting plug 100d further includes a winding portion 140c besides the aforementioned main body 110 and the extending structure 130. The difference between this embodiment and the embodiment of FIG. 9 is that the winding portion 140c is located on the top surface of the male connector plug P, it is an upper type design, and a fastening portion 147b of the winding portion 140c has two opening grooves 141a and 141b, a movable portion 149, and a positioning hook H. The movable portion 149 is located between the two opening grooves 141a and 141b. The positioning hook H connects the movable portion 149. After a tied portion 150b goes around the male connector plug P, the tied portion 150b passes through the positioning hook H so as to be fixed. The movable portion 149 can allow the user to apply a force F1 from one side (e.g., the left side) of the male connector plug P to press and move the positioning hook H, thereby releasing the tied portion 150b. The position limiting plug 100d may be suitable for different male connector plugs P with different shapes and can firmly secure the male connector plug P.

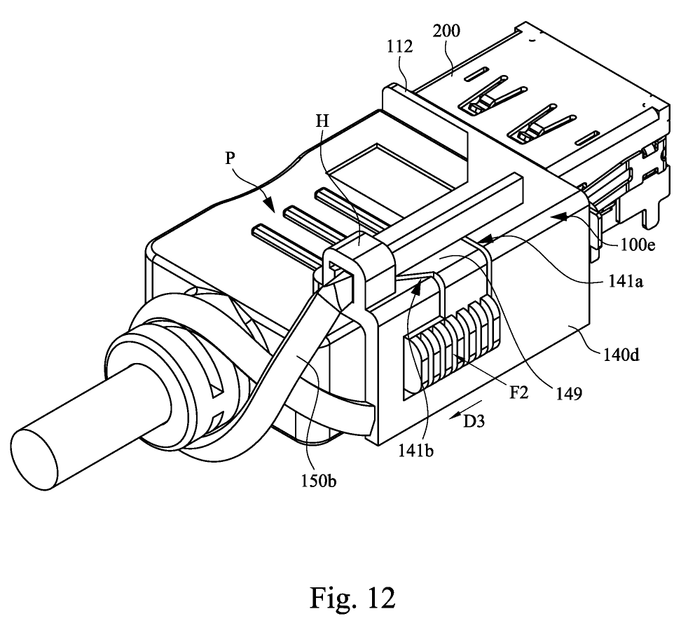

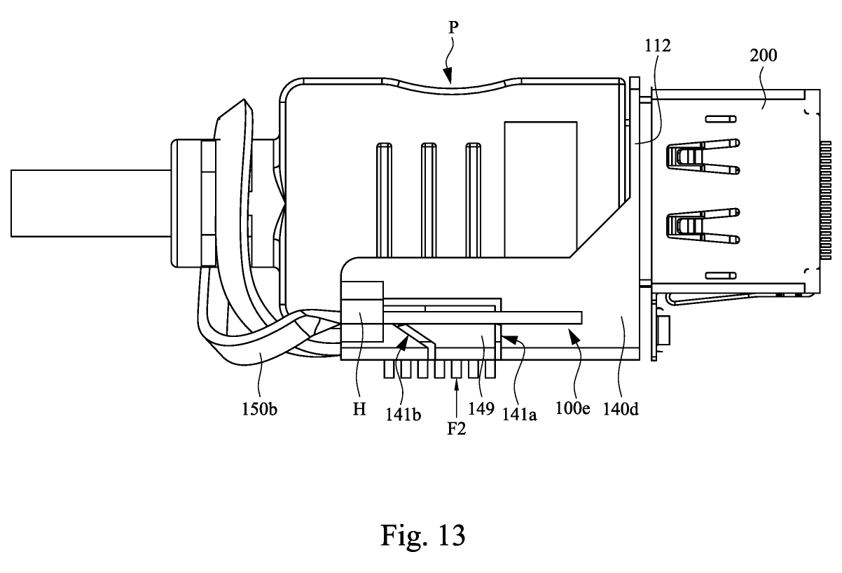

FIG. 12 is a perspective view of a position limiting plug 100e after inserting into the first insertion port 210 of the connector 200 and the male connector plug P after inserting into the second insertion port 220 (see FIG. 4) of the connector 200 according to another embodiment of the present disclosure. FIG. 13 is a top view of FIG. 12. As shown in FIGS. 12 and 13, the position limiting plug 100e further includes a winding portion 140d besides the aforementioned main body 110 and the extending structure 130. The difference between this embodiment and the embodiment of FIG. 10 is that the winding portion 140d is located on the lateral surface of the male connector plug P, it is a side design. After the tied portion 150b goes around the male connector plug P, the tied portion 150b can pass through the positioning hook H so as to be fixed. The movable portion 149 can allow the user to apply a force F2 from one side (e.g., the right side) of the male connector plug P to press and move the positioning hook H, thereby releasing the tied portion 150b. The position limiting plug 100e may be suitable for different male connector plugs P with different shapes and can firmly secure the male connector plug P.

What is claimed is:

1. A position limiting plug for inserting a connector having a first insertion port and a second insertion port that are spatially connected, comprising:
a main body having a stop wall at a rear side of the main body; and
an extending structure extending from a front side of the main body and outwardly towards a direction away from the stop wall, and configured to insert into the first insertion port of the connector, wherein there is a gap between the extending structure and the main body, a bottom surface of the extending structure has an abutting portion adjacent to the gap, and a bottom end of the abutting portion is lower than a bottom surface of the main body, wherein after a male connector plug is inserted into the second insertion port of the connector, the abutting portion is configured to abut against the male connector plug so as to rotate toward the gap.

2. The position limiting plug of claim 1, further comprising:
a winding portion extending in a direction opposite to an extending direction of the extending structure from an edge of the stop wall.

3. The position limiting plug of claim 2, further comprising:
a tied portion, wherein an end of the tied portion extends outward form the winding portion, and another end of the tied portion is configured to go around the male connector plug so as to be positioned on the winding portion after the male connector plug is inserted into the second insertion port of the connector.

4. The position limiting plug of claim 3, wherein the winding portion comprises a fastening portion, and the tied portion is configured to be fixed by the fastening portion after the tied portion goes around the male connector plug.

5. The position limiting plug of claim 4, wherein the fastening portion comprises a first fastening portion and a second fastening portion, the first fastening portion is located below the second fastening portion, each of the first fastening portion and the second fastening portion has a groove, and the tied portion is configured to be sequentially fixed by the groove of the first fastening portion and the groove of the second fastening portion after the tied portion goes around the male connector plug.

6. The position limiting plug of claim 4, wherein the fastening portion comprises a third fastening portion, the tied portion comprises a positioning portion, and the positioning portion of the tied portion is configured to be positioned on the third fastening portion after the tied portion goes around the male connector plug.

7. The position limiting plug of claim 6, wherein the third fastening portion has a positioning protruding portion, the positioning portion has a plurality of through holes, and one of the through holes of the tied portion is configured to allow the positioning protruding portion to pass through to fix after the tied portion goes around the male connector plug.

8. The position limiting plug of claim 4, wherein the fastening portion has two opening grooves, a movable portion, and a positioning hook, the movable portion is located between the two opening grooves, the positioning hook connects the movable portion, the positioning hook is configured to allow the tied portion to pass through to fix, and the movable portion is configured to be pressed to move the positioning hook, thereby releasing the tied portion.

9. A connector assembly, comprising:
a connector having a first insertion port and a second insertion port that are disposed side by side, wherein the first insertion port and the second insertion port are at least partially spatially connected; and
a position limiting plug, comprising:
a main body having a stop wall at a rear side of the main body; and
an extending structure extending from a front side of the main body and outwardly towards a direction away from the stop wall, and configured to insert into the first insertion port of the connector, wherein there is a gap between the extending structure and the main body, a bottom surface of the extending structure has an abutting portion adjacent to the gap, and a bottom end of the abutting portion is lower than a bottom surface of the main body, wherein after a male connector plug is inserted into the second insertion port of the connector, the abutting portion is configured to abut against the male connector plug so as to rotate toward the gap.

10. A connection plug assembly, comprising:
a connection cable comprising a male connector plug and a wire, wherein the male connector plug has a first end and a second end, the first end is configured to insert into a second insertion port of a connector, and the second end connects the wire; and
a position limiting plug connected to the connection cable and comprising:
a main body having a stop wall at a rear side of the main body; and
an extending structure extending from a front side of the main body and outwardly towards a direction away from the stop wall, and configured to insert into a first insertion port of the connector, wherein a bottom surface of the extending structure has an abutting portion, wherein when the extending structure is inserted into the first insertion port and the male connector plug is inserted into the second insertion port, the abutting portion of the extending structure is configured to abut against the male connector plug.

11. The connection plug assembly of claim 10, wherein the position limiting plug further comprises:
a winding portion extending in a direction opposite to an extending direction of the extending structure from an edge of the stop wall.

12. The connection plug assembly of claim 11, wherein the position limiting plug further comprises:
a tied portion, wherein an end of the tied portion extends outward form the winding portion, and the tied portion is configured to enable another end of the tied portion to go around the male connector plug so as to be positioned on the winding portion after the male connector plug is inserted into the second insertion port of the connector.

13. The connection plug assembly of claim 12, wherein the winding portion comprises a fastening portion, and the tied portion is configured to be fixed by the fastening portion after the tied portion goes around the male connector plug.

14. The connection plug assembly of claim 13, wherein the fastening portion comprises a first fastening portion and a second fastening portion, the first fastening portion is located below the second fastening portion, each of the first fastening portion and the second fastening portion has a groove, and the tied portion is configured to be sequentially fixed by the groove of the first fastening portion and the groove of the second fastening portion after the tied portion goes around the male connector plug.

15. The connection plug assembly of claim 13, wherein the fastening portion comprises a third fastening portion, the tied portion comprises a positioning portion, and the positioning portion of the tied portion is configured to be positioned on the third fastening portion after the tied portion goes around the male connector plug.

16. The connection plug assembly of claim 15, wherein the third fastening portion has a positioning protruding portion, the positioning portion has a plurality of through holes, and one of the through holes of the tied portion is configured to allow the positioning protruding portion to pass through to fix after the tied portion goes around the male connector plug.

17. The connection plug assembly of claim 13, wherein the fastening portion has two opening grooves, a movable portion, and a positioning hook, the movable portion is located between the two opening grooves, the positioning hook connects the movable portion, the positioning hook is configured to allow the tied portion to pass through to fix, and the movable portion is configured to be pressed to move the positioning hook, thereby releasing the tied portion.
